(19) United States
(12) Patent Application Publication
(10) Pub. No.: US 2024/0430927 A1
(43) Pub. Date: Dec. 26, 2024

(54) Open Shortest Path First (OSPF) Monitoring Interface for Networking

(71) Applicant: Huawei Technologies Co., Ltd., Shenzhen (CN)

(72) Inventors: Lin Han, Addison, TX (US); Alvaro Enrique Retana, Addison, TX (US)

(21) Appl. No.: 18/823,221

(22) Filed: Sep. 3, 2024

Related U.S. Application Data
(63) Continuation of application No. PCT/US2023/014500, filed on Mar. 3, 2023.
(60) Provisional application No. 63/316,581, filed on Mar. 4, 2022.
(60) Provisional application No. 63/316,268, filed on Mar. 3, 2022.

(51) Int. Cl. H04W 72/563; H04W 24/06; H04W 40/04

(52) U.S. Cl. CPC H04W 72/563; H04W 24/06; H04W 40/04

(57) ABSTRACT

A network routing system and associated methods include a first router in a first network node and a second router in a second network node. The first router may be configured in a local configuration mode to exclude a link to the second router from a link status advertisement (LSA) of the first router, exclude sending a request for an LSA to second router and to ignore any LSA received from the second router. The second router may be configured as a monitor router with a designated router (DR) selection priority set to a lowest priority level and an instruction to transmit a monitor router message providing notification that the second router is configured as a monitor router and has the lowest DR selection priority level.

### CROSS-REFERENCE TO RELATED APPLICATIONS

This is a continuation of International Patent Application No. PCT/US2023/014500 filed Mar. 3, 2023, which claims the benefit of U.S. Provisional Patent Application No. 63/316,581 filed Mar. 4, 2022 and U.S. Provisional Patent Application No. 63/316,268 filed on Mar. 3, 2022, all of which are incorporated herein by reference.

### TECHNICAL FIELD

Open Shortest Path First (OSPF) is a routing protocol for Internet Protocol (IP) networks. The disclosed embodiments relate to networking in general and an OSPF interface for networking in particular.

### BACKGROUND

The OSPF protocol uses a link state routing (LSR) algorithm and falls into the group of interior gateway protocols (IGPs) operating within a single autonomous system (AS). OSPF gathers LSR information from available routers in a network and constructs a topology map of the network. The topology is presented as a routing table to the Internet Layer for routing packets by their destination IP address. OSPF supports Internet Protocol Version 4 (IPv4) and Internet Protocol Version 6 (IPv6) networks.

Artificial satellites, including geostationary orbit (GSO), low earth orbit (LEO), and very low earth orbit (VLEO) satellites, are widely used for military and commercial purposes. Fixed satellite systems provide audio, video, and other data services. Mobile satellite systems connecting remote entities such as vehicles serve as navigation systems. Scientific satellite systems provide meteorological, land survey, and other data for research purposes. Satellites previously communicated only with ground stations (GSs), but are now used to establish networks and communicate with each other. Intuitively, current IGPs such as OSPF could be used for satellite networks. However, in networks having fast and highly mobile nodes and/or many extremely unstable links, such as satellite networks for example, the original OSPF cannot be effectively used without modification.

### SUMMARY

The present disclosure provides a modified OSPF interface adapted to operate in a network having numerous nodes and/or fast moving nodes.

Satellite communication is of interest for fifth-generation plus technology (5G+) and sixth-generation technology (6G). The Third Generation Partnership Project (3GPP) has proposed the integration of NTN (Non-Terrestrial Network) with fifth-generation technology (5G) and internet. In the 3GPP proposal, interaction with and among satellite networks are a topic of concern.

A satellite network is a very different network compared with terrestrial networks. The desire for coverage of a large geographical area with large numbers of rapidly mobile nodes proffers unprecedented challenges to current technology. Layer three (L3) refers to the third layer of the Open Systems Interconnections (OSI) model, which is the network layer used for forwarding between network routers. There is no current L3 technology that can be used directly in an efficient manner in networks having large numbers of fast-moving nodes, such as satellite networks, for example.

The disclosure provides an adaptation applicable to the existing OSPF regime to improve network communications.

A first aspect of the disclosure related to a network routing system includes a first network node comprising a first router, wherein the first router is configured to support a second router configured as a monitor router, a second network node comprising the second router, wherein the monitor router configuration comprises a designation as a monitor router, a designated router (DR) selection priority set to a lowest priority level, and an instruction to transmit a monitor router message, wherein the monitor router message comprises notification that the monitor router has the lowest DR selection priority level and is configured as a monitor router.

Optionally, in the preceding aspect, in another implementation, a monitor router message comprises a Hello packet having a monitor bit (M-bit) indicating that the second network node comprises a monitor router and has a router priority set to zero.

Optionally, in any of the preceding aspects, in another implementation, the first router, based on receiving the monitor router message, ignores a link state advertisement (LSA) received from the monitor router.

Optionally, in any of the preceding aspects, in another implementation, the first router, based on receiving the monitor router message, excludes the link to the monitor router from its router LSA when a link to the monitor router is a point-to-point (P2P) link.

Optionally, in any of the preceding aspects, in another implementation, the first router, based on receiving the monitor router message, excludes the monitor router from its network LSA when a link to the monitor router is a non-broadcast multiple-access (NBMA) link.

Optionally, in any of the preceding aspects, in another implementation, the first router, based on receiving the monitor router message, is further configured to de-select the monitor router as a designated router (DR) when a link to the monitor router is a non-broadcast multiple-access (NBMA) link.

Optionally, in any of the preceding aspects, in another implementation, the first router, based on receiving the monitor router message, is further configured to de-select the monitor router as a backup designated router (BDR) when a link to the monitor router is a non-broadcast multiple-access (NBMA) link.

Optionally, in any of the preceding aspects, in another implementation, the monitor router receives all LSAs from the first router and does not advertise any LSA to the first router.

Optionally, in any of the preceding aspects, in another implementation, the first network node comprises a satellite.

Optionally, in any of the preceding aspects, in another implementation, the second network node comprises a ground station (GS) in a satellite network.

A second aspect of the disclosure, related to a network routing method implemented by a first router in a first network node, discloses configuring the first router of the first network node with a set of instructions for operating in a local configuration, wherein the instructions comprise a do-not-advertise-link instruction, a do-not-request-link-status-advertisement (LSA) instruction, and an ignore-LSA instruction.

Optionally, in the preceding aspect, in another implementation, the first router with the configuration do-not-advertise-link for a monitoring interface link excludes the monitoring router link in its LSA advertised to connected networks.

Optionally, in any of the preceding aspects, in another implementation, the first router with the configuration do-not-request-link-status-advertisement (LSA) and/or the configuration ignore-LSA for a monitoring interface does not request any LSA from a router through the monitoring interface and ignores any LSA received from the monitoring interface.

Optionally, in any of the preceding aspects, in another implementation, the first router is located in a satellite of a satellite network.

A third aspect of the disclosure related to a network routing method implemented by a monitor network node discloses configuring a router of the monitor network node, wherein the configuration comprises setting a router identity as a monitor router, setting a designated router (DR) selection priority of the monitor router to a lowest priority level, and then transmitting a monitor router message comprising a notification that the monitor network node comprises a monitor router and has the lowest DR selection priority level.

Optionally, in the preceding aspect, in another implementation, the monitor router message comprises a Hello packet comprising a monitor bit (M-bit) indicating that the monitor network node comprises a monitor router, and a router priority set to zero.

Optionally, in any of the preceding aspects, in another implementation, based on the monitor router message, a receiving router ignores an LSA received from the monitor router.

Optionally, in any of the preceding aspects, in another implementation, based on the monitor router message, a receiving router excludes a link to the monitor router from a router LSA when a link to the monitor router is in a point-to-point (P2P) link.

Optionally, in any of the preceding aspects, in another implementation, based on the monitor router message, a receiving router excludes the monitor router from a router LSA when a link to the monitor router is a non-broadcast multiple-access (NBMA) link.

Optionally, in any of the preceding aspects, in another implementation, based on receiving the monitor router message, a receiving router de-selects the monitor router as a designated router (DR) when a link to the monitor router is a non-broadcast multiple-access (NBMA) link.

Optionally, in any of the preceding aspects, in another implementation, based on receiving the monitor router message, a receiving router de-selects the monitor router as a backup designated router (BDR) when a link to the monitor router is a non-broadcast multiple-access (NBMA) link.

Optionally, in another implementation, a ground station (GS) in a satellite network is disclosed, comprising a memory configured to store instructions and a processor coupled to the memory and configured to execute the instructions to cause the GS to perform the method of any of the previous aspects.

Optionally, in another implementation, a satellite in a satellite network comprises a memory configured to store instructions and a processor coupled to the memory and configured to execute the instructions to cause the satellite to perform the method of any of the previous aspects.

Optionally, in another implementation, a computer program product comprising computer-executable instructions that are stored on a non-transitory medium and that, when executed by a processor, cause a router in a network to perform the method of any of the previous aspects.

Optionally, in another implementation, a computer program product comprising computer-executable instructions that are stored on a non-transitory medium and that, when executed by a processor, cause a router in a satellite network to perform the method of any of the previous aspects.

For the purposes of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example of a satellite network according to the disclosure.

FIG. 2 is a schematic diagram illustrating a conceptual view of an OSPF network implementing the systems and methods of the disclosure.

FIG. 3 is a schematic depiction of an example of a Hello packet according to embodiments of the disclosure.

FIG. 4 is a flow diagram showing an example of an implementation of an embodiment executed by a router operating in a local configuration mode.

FIG. 5 is a flow diagram showing an example of an implementation of an embodiment executed by a router operating in a monitor mode.

FIG. 6 is flow diagram illustrating an example of the implementation of an example of an embodiment executed by a router receiving a Hello packet from a monitor router.

FIG. 7 is a schematic diagram of an apparatus.

### DETAILED DESCRIPTION

It should be understood at the outset that, although examples of illustrative implementations of one or more embodiments are provided below, the disclosed systems and methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. Although the disclosure uses satellite networks as examples, a person of ordinary skill in the arts will appreciate that the embodiments may be used in any network and are suitable for use with networks having many nodes, fast-moving nodes, or both.

A method, an apparatus, a system, and a computer program product may implement the embodiments.

Examples of current satellite networks include STARLINK and CONSTELLATION. STARLINK is planned to include 11,943 LEO and VLEO satellites by 2027. However, a new plan would increase that number to 46,000. CONSTELLATION is planned to include 12,992 satellites. Other satellite networks, for instance in the European Union (EU), are likely to emerge. It is therefore necessary to develop schemes, including addressing schemes, for networking a large number of satellites.

However, addressing for satellites has challenges due to the velocities of satellites, which exceed 7 kilometers per second (km/s). The coverage radii of satellites, which are in the range of 435-1,230 kilometers (km) also present challenges, as well as the need to flush and recalculate routes due to GS connection changes every 100-400 seconds, and constant changes in network topology. In the context of satellites, current IP addressing may be unstable due to the need to frequently assign addresses while the network topology quickly changes. In addition, current IP addressing uses virtual addresses, which provide network and device information, but not geographical information useful for a quickly-changing network topology.

The OSPF routing protocol can be used for large scale networks. The routing algorithm used for OSPF is of the link-state type. In the link-state type, routers in the network exchange LSAs. A link is a connection between OSPF-enabled interfaces. When the LSAs are flooded through the network, they describe routes within a given link. By exchanging the state of the links in LSAs, each OSPF router can have a detailed view of the network.

The LSAs exchanged by the OSPF routers are stored in a link state database (LSDB). The LSDB is the detailed network structure that each OSPF router can access. With this information, a shortest path first (SPF) algorithm is used to determine the best route and create a routing table. In large networks, the number of LSAs, as well as the size of the LSDB, can be very large, which requires a lot of computer processing cycles and memory in the routers. This is undesirable. To mitigate these problems, OSPF can also apply the concept of segmenting the network into “areas” to enable more efficient routing in large networks. In this way, a set of routers can be limited to exchange LSAs with others in the same area, which limits the number of LSAs somewhat and encourages aggregate routes.

The most basic LSA, sometimes called a “Type 1 LSA”, is generated by all OSPF routers. The router LSAs are all transmitted within an area of a network. The LSA contains all of the OSPF-enabled router link information. The link information includes the type of link, cost, IP address, and router ID of neighbor routers. Neighbor routers are defined as two routers that share a common link and can communicate with each other. The information included in the LSA can vary depending on the type of link.

A DR is a router that represents a multi-access network. The network LSA shows the connection of an OSPF router on a multi-access network. It contains the IP address of the DR, a list of routers connected to the multi-access network and the subnet mask of the multi-access network. Network LSAs generated by the DR are flooded to all routers within the area except in the case of a P2P network. Similarly, a BDR is a backup for the DR.

A Hello protocol is used by routers on a network to determine their neighbors and generate appropriate LSAs. Hello packets are the first packets, or messages, sent and received for OSPF processing. OSPF Hello packets are used by routers on a network to discover and maintain neighbors. The destination IP address of a Hello packet is usually a multicast address representing all OSPF routers. When running OSPF protocol over a NBMA network, the IP address specified in the neighbor becomes the destination IP address.

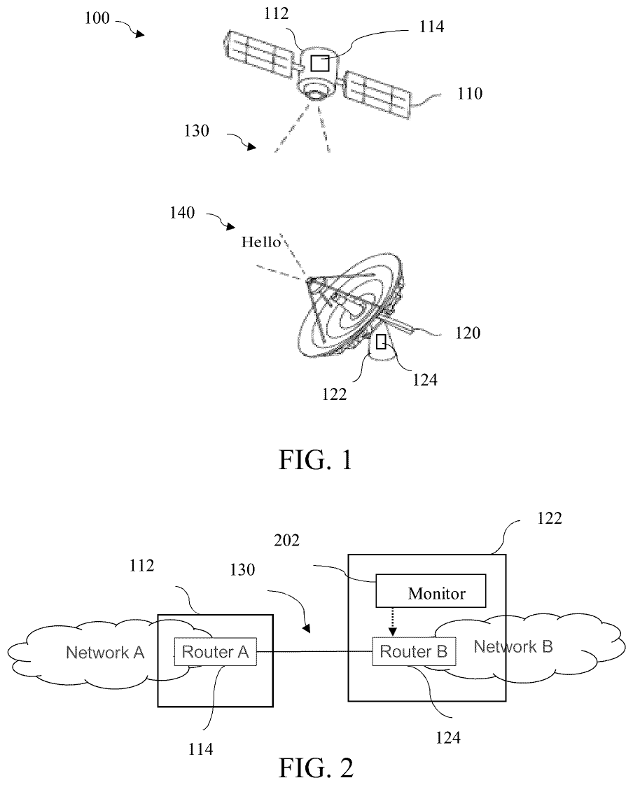

FIG. 1 is a schematic diagram of a an example of a satellite network 100. The satellite network 100 includes one or more satellite 110 and one or more GS 120. The satellites in the network may be geosynchronous, LEO, VLEO, or other satellites. Though one satellite 110 and one GS 120 are shown in this simplified example, the satellite network 100 may include any suitable number of satellites and GSs. As an example, a satellite network designed to provide coverage to a large portion of the surface of the Earth may implement 20 orbits and comprises either 22-23 LEO satellites per orbit or 48-62 VLEO satellites per orbit, totaling 440-1,240 satellites to substantially cover the Earth. The satellite 110 includes a first node 112 equipped with a first router 114. The GS 120 includes a second node 122 and a second router 124. Thus, an interface 130 is defined for communication between the nodes 112, 122 of the network 100.

The implementation of the systems and methods of this disclosure make use of the predictability of the satellite-to-GS links. The satellite time and orbit parameters and the GS coordinates are known. Thus, the links between satellites and GSs are predictable for the following cases: a GS cannot connect to a satellite when the satellite-to-GS distance is greater than a specified limit; a GS can connect to a satellite when the satellite-to-GS distance is less than a specified limit; a GS is likely to connect to a satellite when the satellite-to-GS distance is a minimum distance; a GS is likely to connect to a plurality of satellites when the distances to the plurality of satellites are all within a specific limit. Because the satellite-to-GS links can be detected, there is no need to have OSPF retain the satellite-to-GS link states and LSAs from GSs.

In an embodiment, a router system and method can be implemented for an OSPF network. In an embodiment, a special interface type is defined for the OSPF network. To facilitate the interface 130 between the routers 114, 124, one side of the interface, the router 124 at second node 122 at the GS 120 for example, can be configured to monitor the OSPF network 100 through the unstable links of the network while preventing the unstable links from impacting the OSPF network stability. A source node, first node 112 at the satellite 110 for example, in the network is able to collect network information for the purpose of source routing path calculation, but does not permit its own network information to appear in the OSPF network 100 or to impact the routing. By monitoring an OSPF network silently without impacting the routing in the OSPF network 100, the OSPF functions on both nodes 112, 122 of the interface are asymmetric.

The relationships between nodes in an OSPF network can be defined as two types. Neighbor is the relationship between OSPF routers on the same network. Neighbor nodes are discovered using Hello packets, or messages, as further described below. Adjacency is the relationship between OSPF routers that exchange LSAs. A P2P has only two OSPF routers connected to the same network, therefore, neighbor is adjacency. In a broadcast network, however, two or more OSPF routers may be connected on the same network, thus neighbor is not necessarily adjacency. IGP adjacency changes and LSAs generated by link flipping can be controlled to prevent unnecessarily populating them to an entire OSPF network.

Two operation modes are disclosed in the embodiments. A local configuration mode can be implemented at one node of an OSPF interface. As the term is used herein, a router operating as a router designated to control the adjacency and LSA population within the network is termed a local configuration router, while another node of the interface (any other router in communication with the local configuration router) need not be aware of the local configuration mode of the local configuration router. In another operation mode termed a monitoring mode, a router on one node of the interface is configured to give notification of its status as a “monitor router” which triggers another node of the interface (any other router in communication with the monitor router) to react accordingly as further described.

FIG. 2 is a schematic diagram illustrating a conceptual view of a system and method of satellite network addressing for interfacing 130 between networks. A first network A includes a first network node 112 having a first router 114. A second network B includes a second node 122 with a second router 124. The second router 124 may in some embodiments have a designation as a router adapted to function as a monitor router 202 as further described.

In one example, Network A includes first router 114 adapted to function as in a local configuration mode. In order to configure first router 114 in a local configuration mode, the following local parameters are defined for implementation at the first router 114:
Do-Not-Advertise-Link: When configured at first router 114, the monitoring interface (link) is not included in first router 114's LSA and is not advertised to its connected network (Network A in the example);
Do-Not-Request-LSA: When configured at first router 114, first router 114 does not request an LSA from the second router 124 at the second node 122; and
Ignore-LSA: When configured at first router 114, first router 114 ignores all LSAs received from the second router 124.

It should be understood that in this implementation first router 114 is configured to function in a local configuration mode and router 124 at node 122 in Network B does not receive any configuration modification and operates without departure from ordinary OSPF interface procedures.

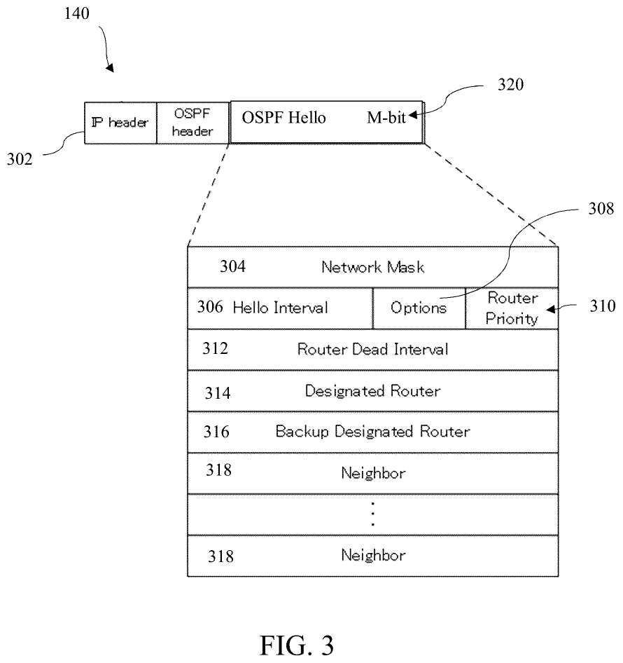

In another implementation, further referring to FIG. 2, Network B includes router 124. Router 124 in this embodiment is configured as a “monitor router” indicated at reference numeral 202. The monitor router 202, implemented in a GS in a satellite network for this example, includes one bit (M-bit) in a Hello packet 140 further described with reference to FIG. 3 below. The Hello packet 140 sent to the neighbor nodes notifies the neighbor nodes that router 124 is a currently operating as a monitor router 202. In addition, the designated router (DR) selection priority of the monitor router 202 is indicated in the Hello packet 140 to be the lowest priority, zero. The monitor router 202 does not advertise any LSA to network B neighbor nodes. The monitor router 202 receives all LSAs from other OSPF neighbor nodes in accordance with ordinary OSPF procedure, for example from first router 114 in node 112 in Network A. In response to receiving the notification that router 124 is currently configured as a monitor router 202, the behavior of first router 114 is adapted to ignore and not advertise any LSA received from the monitor router 124.

FIG. 3 shows an example of a Hello packet 140 sent in embodiments using a monitor router configuration 202. OSPF packets have a 24-byte OSPF header 302 to identify the type of OSPF packet. Hello packets are identified as type 1 and are addressed to all nodes in a network. The Network Mask (32 bits) 304 is the subnet mask of the interface, e.g., 130, to which the Hello packet 140 is sent. In order to be a neighbor, the Network Mask must match; for an interface whose IP address is set to IP unnumbered, the Network Mask is 0.0.0.0.

The Hello Interval (16 bits) 306 is the interval for sending Hello packets, and the default Hello Interval is 10 seconds in the current environment. Options (8 bits) 308, indicates various OSPF router capabilities.

Router Priority (8 bits) 310 is used to select DR/BDR in a multi-access network. The router with the higher Router Priority is selected as DR/BDR. If the Router Priority is set to zero, the router, in this case router 202, does not participate in the DR/BDR selection.

If no Hello packets are received for a period of Router Dead Interval (32 bits) 312, the neighbor is considered down. The Router Dead Interval must also match in order to establish a neighbor.

The Designated Router (32-bit) 314 contains the IP address of the DR, which is “0.0.0.0” when the DR is being selected or when the network type is P2P without DR/BDR selection.

The Backup Designated Router (32-bit) 316 contains the IP address of the BDR, which is “0.0.0.0” when the BDR is being selected or when the network type is P2P without DR/BDR selection.

Neighbor (32 bits) 318 stores the router ID that is recognized as a neighbor. The initial value is “0.0.0.0”. If there are multiple neighbors, Neighbor will have multiple lines. In order to establish a neighbor with an OSPF Hello packet, the following information contained in the Hello packet must match: Area ID (OSPF header); AuType/Authentication (OSPF header); Network Mask; Hello Interval; Dead Interval; Options (E/N bit).

In embodiments having a monitor router configuration 202, the Hello packet 140 includes an M-bit 320 that notifies recipients that the Hello packet 140 is received from a monitor router 202.

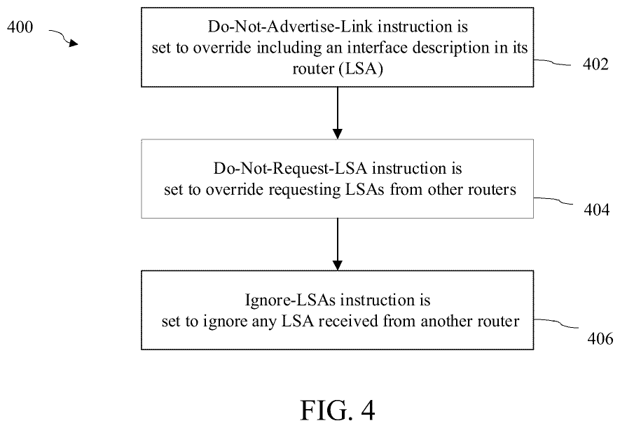

FIG. 4 is a network routing method 400 according to an embodiment of the disclosure. In an embodiment, the routing method 400 is implemented by the first router 114 in the first network node 112 as shown in FIGS. 1 and 2. When the method is implemented, the first router 114 is adapted to operate in a local configuration mode. The Do-Not-Advertise-Link instruction 402 indicates whether or not the link is to be advertised on the local router LSA. When enabled, the first router 114 will not include a corresponding interface description in its router LSA. The first router 114 will also not originate other LSAs related to the link or its addresses. Enabling this interface parameter overrides any contrary instructions that may have been preprogrammed such as, for example, an OSPF setting of LinkLSASuppression. The Do-Not-Request-LSA instruction 404 indicates whether or not the first router 114 will request LSAs from other routers on the monitoring link interface, e.g., monitor router 202. When enabled, the first router 114 will consider its link state request list as being empty. The Ignore-LSA instruction 406 causes the first router 114 to consider the age of any received LSA to be equal to its maximum age and process the received LSA accordingly.

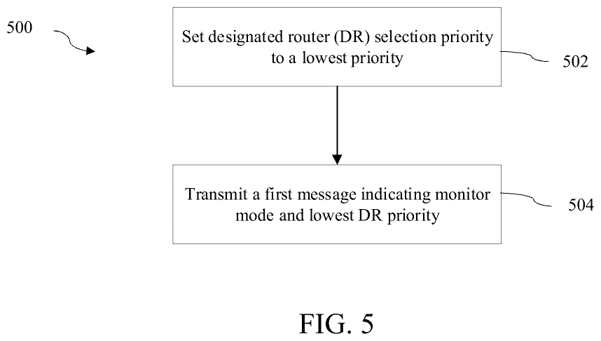

FIG. 5 is network routing method 500 according to an embodiment of the disclosure. In an embodiment, the routing method 500 is implemented by the second router 124 operating with the monitor router configuration 202 in the second network node 122 as shown in FIGS. 1 and 2. The monitor router 202 priority is set to zero 502. A Hello packet 140 sent by the monitor router 202 includes information indicating to any recipient that it has the status of monitor router and a lowest priority setting of zero 504. As shown in FIG. 3, the monitor router status may be indicated by a single bit, e.g., M-bit 320 in the Hello packet 140.

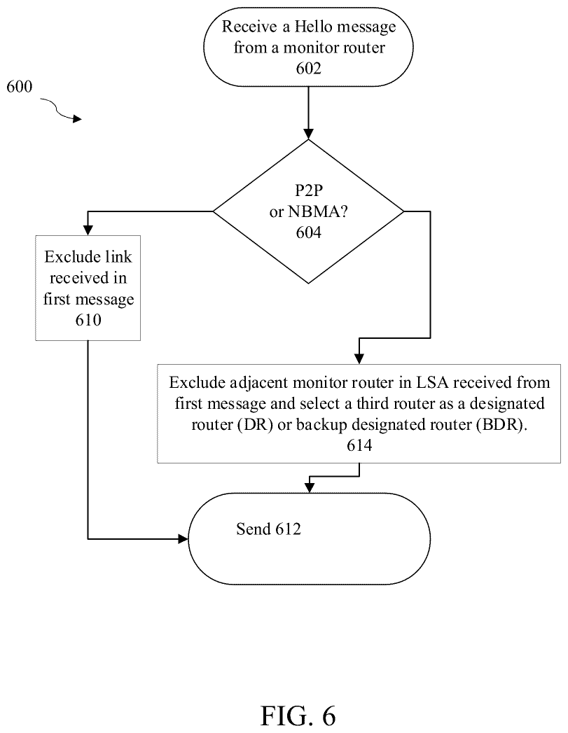

FIG. 6 is a routing method 600 according to an embodiment of the disclosure. In an embodiment implemented by a router receiving a monitor router message 140, a router (e.g., first router 114 in FIGS. 1 and 2) receives 602 a Hello packet 140 identifying the sender of the Hello packet as a monitor router 202 as described above. A determination is made 604 as to whether the Hello packet is received in a P2P link 606 or received in an NBMA link 608. When the link is determined to be a P2P link 606, the receiving router excludes the monitor router link from a router LSA 610 when sending an LSA in the network 612. When the link is determined to be a NBMA link 608, the receiving router treats the monitor router as ineligible for any DR and BDR selection 614, and the receiving router excludes the monitor router link from a router LSA when sending an LSA in the network 612.

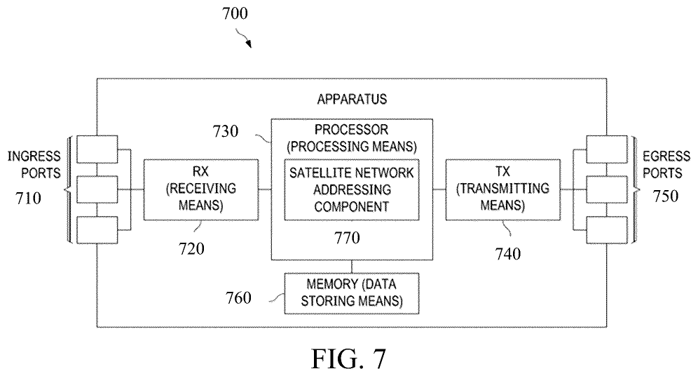

FIG. 7 is a schematic diagram of an apparatus 700. The apparatus 700 may implement the disclosed embodiments. The apparatus 700 comprises ingress ports 710 and an receiving means (RX) 720 or receiving means to receive data; a processor 730 or processing means, or logic unit, baseband unit, or central processing unit (CPU), to process the data; a transmitting means (TX) 740 or transmitting means and egress ports 750 to transmit the data; and a memory 760 or data storing means to store the data. The apparatus 700 may also comprise optical-to-electrical (OE) components, electrical-to-optical (EO) components, or radio frequency (RF) components coupled to the ingress ports 710, the RX 720, the TX 740, and the egress ports 750 to provide ingress or egress of optical signals, electrical signals, or RF signals.

The processor 730 is any combination of hardware, middleware, firmware, or software. The processor 730 comprises any combination of one or more CPU chips, cores, field-programmable gate arrays (FPGAs), application-specific integrated circuits (ASICs), or digital signal processors (DSPs). The processor 730 communicates with the ingress ports 710, the RX 720, the TX 740, the egress ports 750, and the memory 760. The processor 730 comprises a satellite network addressing component 770, which implements the disclosed embodiments. The inclusion of the satellite network addressing component 770 therefore provides a substantial improvement to the functionality of the apparatus 700 and effects a transformation of the apparatus 700 to a different state. Alternatively, the memory 760 stores the satellite network addressing component 770 as instructions, and the processor 730 executes those instructions.

The memory 760 comprises any combination of disks, tape drives, or solid-state drives. The apparatus 700 may use the memory 760 as an over-flow data storage device to store programs when the apparatus 700 selects those programs for execution and to store instructions and data that the apparatus 700 reads during execution of those programs. The memory 760 may be volatile or non-volatile and may be any combination of read-only memory (ROM), random-access memory (RAM), ternary content-addressable memory (TCAM), or static-RAM (SRAM).

A computer program product may comprise computer-executable instructions that are stored on a non-transitory medium and that, when executed by a processor, cause an apparatus to perform any of the embodiments. The non-transitory medium may be the memory 760, the processor may be the processor 730, and the apparatus may be the apparatus 700.

One of ordinary skill in the art should recognize that this disclosure provides the capabilities of a monitor network node configured to receive information from its neighbors and to refrain from sending information to its neighbor nodes. In this way, the LSAs from the monitor network node can be ignored to prevent unneeded LSAs from being flooded throughout the network.

While several embodiments have been provided in the present disclosure, it should be understood that the disclosed systems and methods could be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, used in a different context, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically. mechanically, or otherwise. Other examples of changes, substitutions, and alterations are ascertainable by one skilled in the art and may be made without departing from the spirit and scope disclosed herein.

What is claimed is:

1. A network routing system, comprising:
a first network node comprising a first router configured to support a second router; and
a second network node comprising the second router, the second router configured as a monitor router having a configuration comprising:
a designation as the monitor router;
a designated router (DR) selection priority set to a lowest priority level; and
an instruction to transmit a monitor router message comprising a notification that the second router has the DR selection priority set to the lowest priority level and is configured as the monitor router.

2. The network routing system of claim 1, wherein the monitor router message includes a Hello packet comprising:
a monitor bit (M-bit) indicating that the second network node comprises the monitor router; and
a router priority set to zero.

3. The network routing system of claim 1, wherein the first router, based on receiving the monitor router message, ignores a link status advertisement (LSA) received from the second router.

4. The network routing system of claim 1, wherein the first router, based on receiving the monitor router message, excludes a link to the second router from a link status advertisement (LSA) of the first router when the link to the second router is a point-to-point (P2P) link.

5. The network routing system of claim 1, wherein the first router, based on receiving the monitor router message, excludes the second router from a link status advertisement (LSA) of the first router when a link to the second router is a non-broadcast multiple-access (NBMA) link.

6. The network routing system of claim 1, wherein the first router, based on receiving the monitor router message, is configured to de-select the second router as a designated router (DR) when a link to the second router is a non-broadcast multiple-access (NBMA) link.

7. The network routing system of claim 1, wherein the first router, based on receiving the monitor router message, is configured to de-select the second router as a backup designated router (BDR) when a link to the second router is a non-broadcast multiple-access (NBMA) link.

8. The network routing system of claim 1, wherein the second router receives all link status advertisements (LSAs) from the first router and does not advertise any LSA to the first router.

9. The network routing system of claim 1, wherein the first network node comprises a satellite.

10. The network routing system of claim 1, wherein the second network node comprises a ground station (GS) in a satellite network.

11. A network routing method implemented by a first network node, comprising:
configuring a first router of the first network node with a set of instructions for a monitoring interface link, the instructions comprising:
a do-not-advertise-link instruction;
a do-not-request-link-status-advertisement instruction; and
an ignore-LSA instruction.

12. The network routing method of claim 11, wherein the first router excludes the monitoring interface link from a link status advertisement (LSA) of the first router advertised to connected networks when the first router has a do-not-advertise-link configuration.

13. The network routing method of claim 11, wherein the first router does not request any link status advertisement (LSA) from any other router through the monitoring interface link when the first router has a do-not-request-link-status-advertisement configuration, and wherein the first router ignores any LSA received through the monitoring interface link when the first router has an ignore-LSA configuration.

14. The network routing method of claim 11, wherein the first router is located in a satellite of a satellite network.

15. A network routing method implemented by a monitor network node, comprising:
configuring a router of the monitor network node by:
setting a router identity of the router to monitor router;
setting a designated router (DR) selection priority of the router to a lowest priority level; and
transmitting a monitor router message comprising a notification that the monitor network node includes the router, the router has the DR selection priority set to the lowest priority level, and the router is configured as the monitor router.

16. The network routing method of claim 15, the monitor router message further comprising:
a Hello packet comprising a monitor bit (M-bit) indicating that the monitor network node comprises the monitor router; and
a router priority set to zero.

17. The network routing method of claim 15, wherein the monitor router message instructs a receiving router to ignore a link status advertisement (LSA) received from the router.

18. The network routing method of claim 15, wherein the monitor router message instructs a receiving router to exclude a link to the router from a link status advertisement (LSA) of the receiving router when the link to the router is a point-to-point (P2P) link.

19. The network routing method of claim 15, wherein the monitor router message instructs a receiving router to exclude the router from a link status advertisement (LSA) of the receiving router when a link to the monitor router is a non-broadcast multiple-access (NBMA) link.

20. The network routing method of claim 15, wherein the monitor router message instructs a receiving router to de-select the router as a designated router (DR) when a link to the router is a non-broadcast multiple-access (NBMA) link.

21. The network routing method of claim 15, wherein the monitor router message instructs a receiving router to de-select the router as a backup designated router (BDR) when a link to the router is a non-broadcast multiple-access (NBMA) link.
